(19) United States
(12) Patent Application Publication
(10) Pub. No.: US 2015/0358816 A1
(43) Pub. Date: Dec. 10, 2015

(54) GROUP AUTHENTICATION IN BROADCASTING FOR MTC GROUP OF UES

(71) Applicant: NEC CORPORATION, Tokyo (JP)

(72) Inventors: Xiaowei ZHANG, Tokyo (JP); Anand Raghawa PRASAD, Tokyo (JP)

(21) Appl. No.: 14/760,319

(22) PCT Filed: Dec. 4, 2013
(86) PCT No.: PCT/JP2013/083272

§ 371 Date: Jul. 10, 2015

(30) Foreign Application Priority Data
Jan. 10, 2013 (JP) 2013-002982

(51) Int. Cl. H04W 12/06; H04L 29/06

(52) U.S. Cl. CPC H04W 12/06; H04L 63/02; H04L 63/08

(57) ABSTRACT

Each of a group of MTC UEs (10_{—}1 to 10_n) is configured with a first group key (Kgr) for a group GW (20) to authenticate each of the MTC UEs (10_{—}1 to 10_n) as a member of the group. The group GW (20) is also configured with the first group key (Kgr) for authenticating each of the MTC UEs (10_{—}1 to 10_n) as the member of the group. The group GW (20) can be configured with a second group key (Kgw) for an MME (30) to determine whether or not to allow the group GW (20) to broadcast a message to the MTC UEs (10_{—}1 to 10_n).

### TECHNICAL FIELD

The present invention relates to a security solution for group authentication in Machine-Type Communication (MTC) in broadcasting.

### BACKGROUND ART

The 3GPP (3rd Generation Partnership Project) architecture of MTC is disclosed in NPL 1.

Note that in this application, the term “UE (User Equipment)” is used for UEs that are capable of machine type communication and service. It is the same in meaning as the terms “MTC UE” and “MTC device” through the whole description.

### CITATION LIST

### Non Patent Literature

NPL 1: 3GPP TS 23.682, “Architecture enhancements to facilitate communications with packet data networks and applications (Release 11)”, V11.2.0, 2012-09

NPL 2: 3GPP TS 33.401, “3GPP System Architecture Evolution (SAE); Security architecture (Release 12)”, V12.5.1, 2012-10

### Patent Literature

PTL 1: International Patent Publication No. WO 2012/018130

### SUMMARY OF INVENTION

### Technical Problem

Inventors of this application have found that there are some problems for MTC UEs as follows:

1) Authentication happens at the same time can overload the network.

2) MTC UE needs to have mutual authentication to the network not only as an individual but also as a group member.

3) New keys are needed for securing group messaging.

Accordingly, an exemplary object of the present invention is to at least perform group authentication by broadcasting such that network usage can be saved.

### Solution to Problem

In order to achieve the above-mentioned object, some assumptions and pre-configurations are made for the present invention as follows:

1) SCS (Service Capability Server) knows the external group ID (identifier) and can use it to activate a group and communicate with the group of MTC UEs.

2) UEs are preconfigured with the local group ID(s) that they can belong to and communicate through, and a group key Kgr.

3) Group GW (gateway) is configured with a Kgr and Kgw. Kgr and Kgw can be the same key.

4) HSS (Home Subscriber Server) stores the subscription related data, a whitelist (optional) contains group ID and UE IDs that belong to the group.

Note that in the description of this application, MME (Mobility Management Entity) is used as an example but the mechanism should be the same for SGSN (Serving GPRS (General Packet Radio Service) Support Node) and MSC (Mobile Switching Centre).

The group key Kgr configured in UE can be derived from the root key K for 3GPP communication or can be a different key.

HSS stores the same Kgr and Kgw. It can compute a XRES (Expected Response) with the key and sends it to MME, in the same way of NPL 2.

The group GW was proposed in a separate invention of PTL 1. The group GW receives group message and send it to MTC devices. It can be a logical function installed in any network node or an independent node in network or installed at UE side.

### Advantageous Effects of Invention

According to the present invention, it is possible to solve at least one of the above-mentioned problems, and thereby to at least perform group authentication by broadcasting such that network usage can be saved.

### BRIEF DESCRIPTION OF DRAWINGS

[FIG. 1]

FIG. 1 is a block diagram showing a configuration example of a communication system according to an exemplary embodiment of the present invention.

[FIG. 2]

FIG. 2 is a sequence diagram showing a part of operations in the communication system according to the exemplary embodiment.

[FIG. 3]

FIG. 3 is a sequence diagram showing an example of group authentication by broadcasting to group GW in the communication system according to the exemplary embodiment.

[FIG. 4]

FIG. 4 is a sequence diagram showing an example of group authentication by broadcasting to UE in the communication system according to the exemplary embodiment.

[FIG. 5]

FIG. 5 is a block diagram showing a configuration example of an MTC device according to the exemplary embodiment.

[FIG. 6]

FIG. 6 is a block diagram showing a configuration example of a gateway according to the exemplary embodiment.

[FIG. 7]

FIG. 7 is a block diagram showing a configuration example of a network node according to the exemplary embodiment.

### DESCRIPTION OF EMBODIMENTS

Hereinafter, an exemplary embodiment of the present invention will be described with reference to the accompanying drawings.

In this exemplary embodiment, there are typically proposed two solutions for network performing group authentication by broadcasting such that it can save network usage.

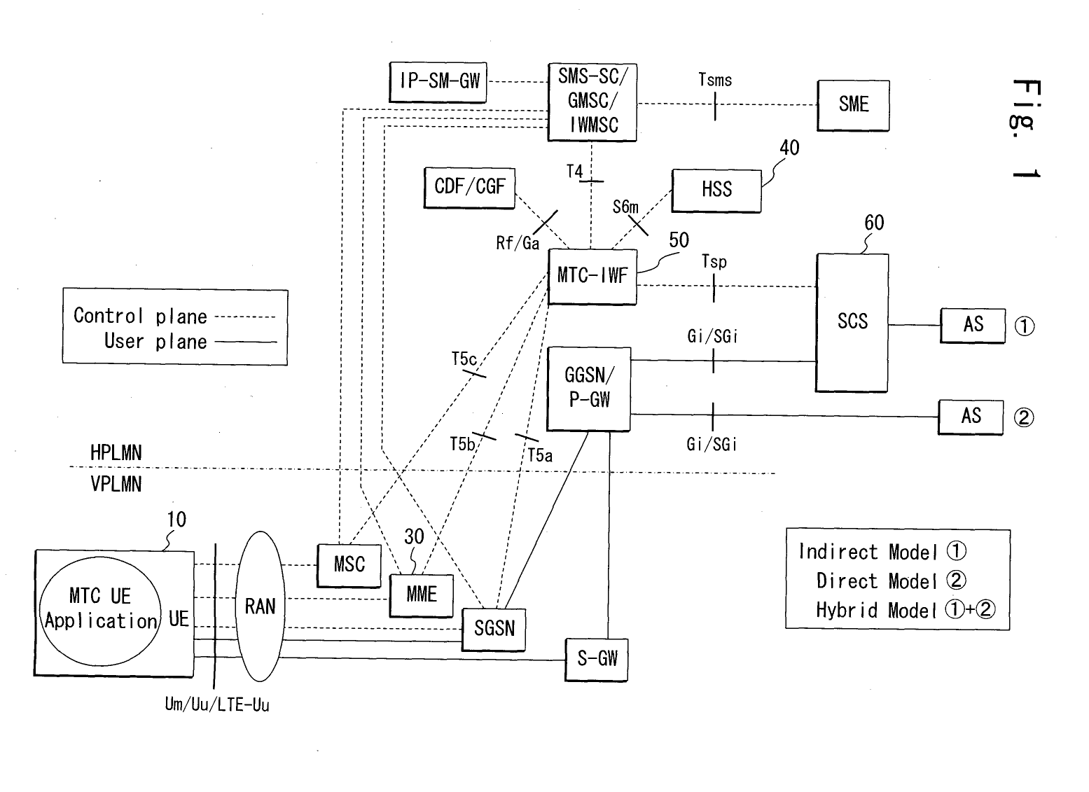

As shown in FIG. 1, a communication system according to this exemplary embodiment includes a core network (3GPP network), and a plurality of MTC UEs 10 which connect to the core network through a RAN (Radio Access Network). While the illustration is omitted, the RAN is formed by a plurality of base stations (i.e., eNBs (evolved Node Bs)).

The MTC UEs 10 attach to the core network. The MTC UEs 10 can host one or multiple MTC Applications. The corresponding MTC Applications are hosted on one or an SCS 60. The SCS 60 connects to the core network to communicate with the MTC UEs 10.

Further, the core network includes, as network nodes, an MME 30, an HSS 40 and an MTC-IWF (MTC Inter-Working Function) 50. The MTC-IWF 50 serves as a gateway to the core network for the SCS 60. The HSS 40 stores subscription information on a group of MTC UEs 10_1 to 10_n (n≧2). The MME 30, as well as an SGSN and an MSC relay traffic between the MTC UEs 10 and the MTC-IWF 50.

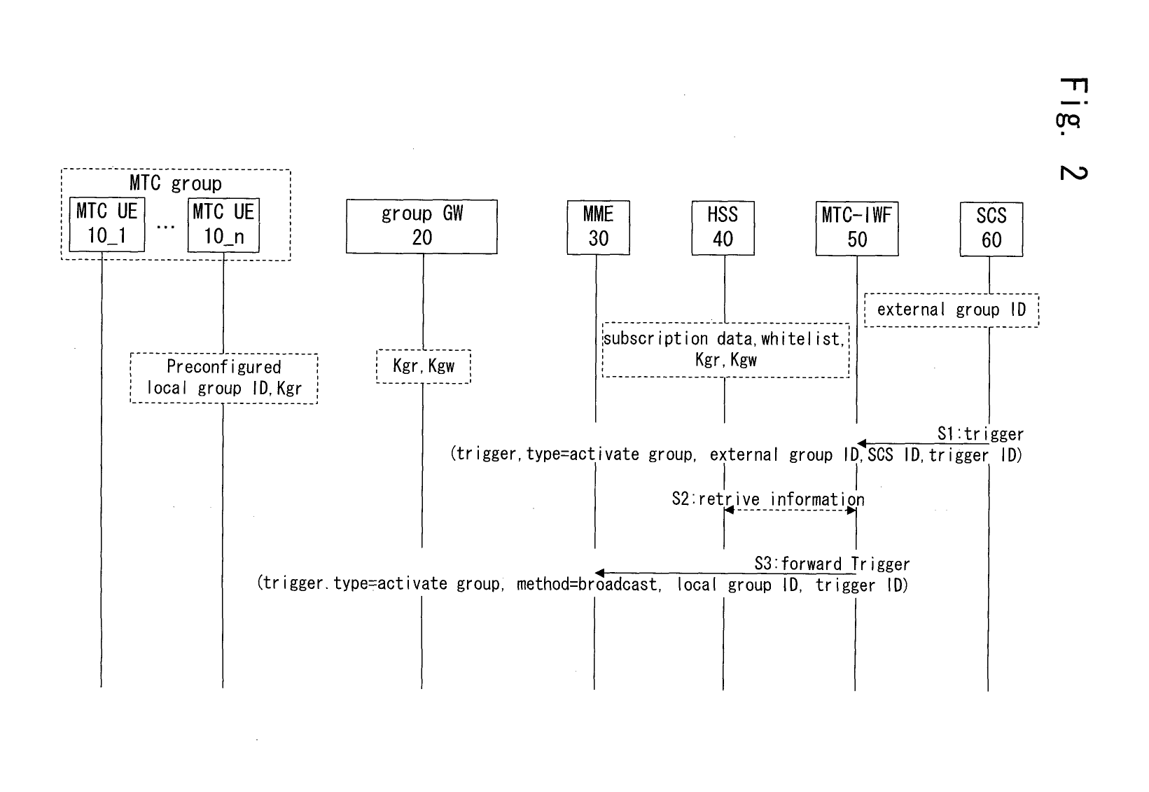

Furthermore, a group GW 20 shown in each of FIGS. 2 to 4 serves as a gateway to the core network for the MTC UEs 10. The group GW 20 may be an independent node placed within the core network or the RAN, or may be a logical function installed in the eNB, MME, SGSN, MSC, HSS or MTC-IWF.

Next, operations in this exemplary embodiment will be described with reference to FIGS. 2 to 4. FIGS. 2 to 4 gives detailed message sequence description of how authentication can be carried by network sending broadcasting message.

As shown in FIG. 2, the following steps S1 to S3 are performed in advance to group authentication.

S1: SCS 60 sends a trigger to MTC-IWF 50, with trigger type of activate group, including external group ID, SCS ID and trigger ID.

S2: MTC-IWF 50 retrieves necessary information for the given group, for example routing information.

Specifically, MTC-IWF 50 sends Subscriber Information Request, reuse the message disclosed in NPL 1, with external group ID, indication of activate group request and the source SCS ID. HSS 40 performs the verification of whether the external group ID is valid, whether any data available for this group, if SCS can trigger to activate the group, is there already a local group ID mapped to it. After proper verification, HSS 40 sends the Subscriber Information Response message to MTC-IWF 50, with local group ID and serving MMEs. Optionally, HSS 40 can send information necessary for the verification and MTC-IWF 50 performs the verification.

S3: MTC-IWF 50 forwards the trigger message to MME 30, with local group ID and trigger method of broadcast.

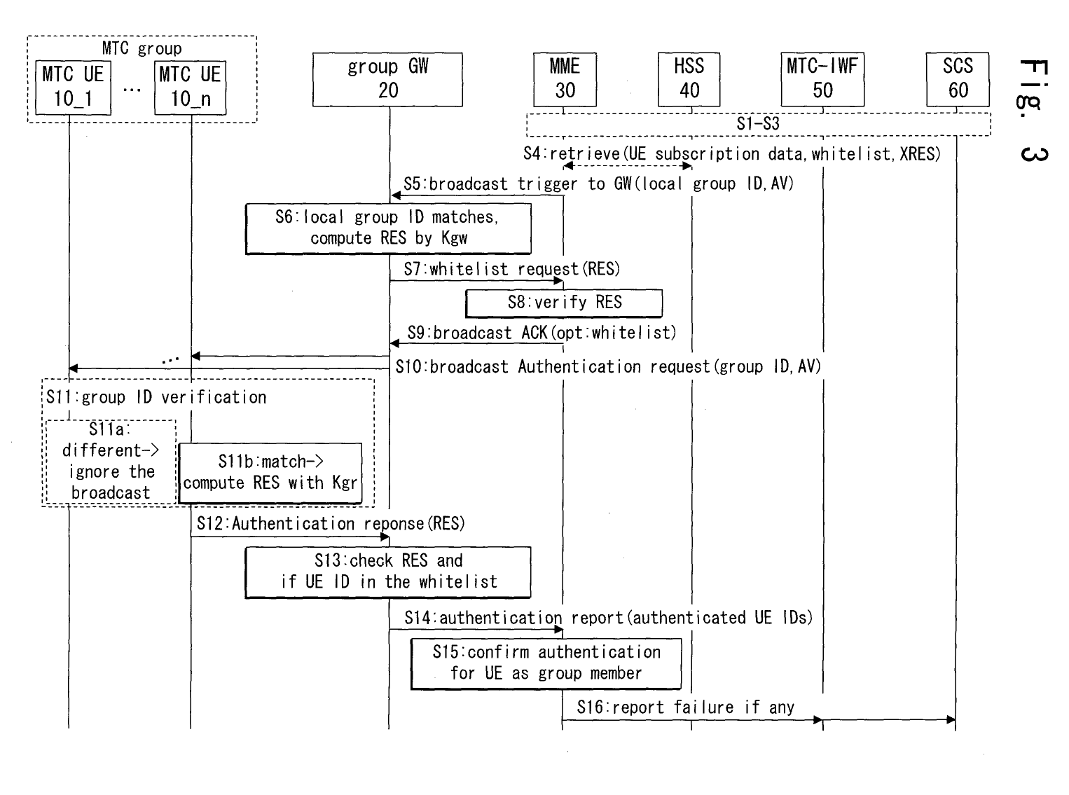

As shown in FIG. 3, in a case where the MME 30 broadcasts the authentication request to group GW 20, the following steps S4 to S16 are performed.

S4: MME 30 retrieves UE subscription data, whitelist (optional), and a XRES computed by Kgw from HSS 40.

S5: MME 30 broadcasts the trigger indicating authentication to GW with local group ID and an AV (authentication vector) including a RAND (random number) and AUTN (authentication token).

S6: When a group GW 20 has a match with the local group ID, it computes a RES (authentication response) on RAND with its configured key Kgw.

S7: Group GW 20 sends the RES to MME 30, optionally sends the whitelist request.

S8: MME 30 verifies the RES, by checking with XRES.

S9: If the verification is passed at step S8, MME 30 sends the broadcast ACK to indicate that group GW 20 can send broadcast message to UEs 10, with whitelist (optional) to group GW 20.

S10: Group GW 20 broadcasts Authentication Request to UEs 10 with group ID and a RAND value.

S11: Each of the MTC UEs 10_1 to 10 n receives the Authentication Request, and then verifies the group ID included in the Authentication Request as the following steps S11a and S11b.

S11a: UEs which have different group ID will ignore the broadcast.

S11b: UEs which have the same group ID configured will compute a RES with the Kgr preconfigured, and also check the AUTN.

S12: UE sends Authentication Response to group GW 20 contains the RES.

S13: Group GW 20 will check the RES and check whether the UE ID is valid against the whitelist (checking against whitelist is optional).

S14: Group GW 20 sends an authentication report to MME 30, contains the authenticated UE IDs.

S15: MME 30 confirms the UEs authenticated as group member.

S16: MME 30 reports authentication failure to MTC-IWF 50 if there is any, and MTC-IWF 50 can forward this to SCS 60.

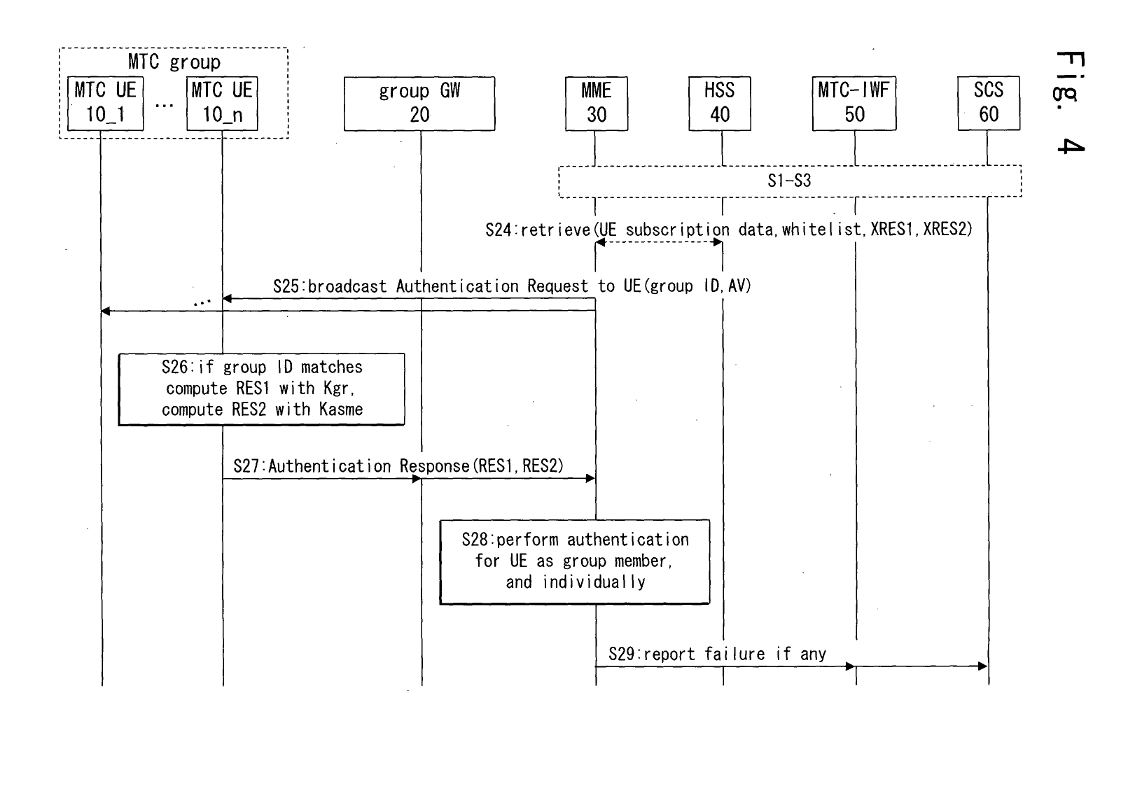

Alternatively, as shown in FIG. 4, in a case where the MME 30 broadcasts the authentication request to UEs 10, the following steps S24 to S29 are performed.

S24: MME 30 retrieves UE subscription data, whitelist (optional), and XRES1 (computed by Kgr), XRES2 (computed by Kasme (Key Access Security Management Entity)) from HSS 40.

S25: MME 30 broadcasts the Authentication Request to UEs 10 with local group ID and AV contains a RAND and AUTN.

S26: UE which has the same group ID will check the AUTN, compute a RES1 with preconfigured group key Kgr, and compute a RES2 with Kasme as in 3GPP AKA (Authentication and Key Agreement) procedure.

S27: UE sends Authentication Response to MME 30 with the RES1 and RES2.

S28: MME 30 verifies RES1 and RES2 by checking with XRES1 and XRES2. Such that it can authenticate the UEs 1) as a group member by verifying RES1 and 2) as an individual by verifying RES2.

S29: MME 30 reports authentication failure to MTC-IWF 50 if there is any, and MTC-IWF 50 can forward this to SCS 60.

Note that as described in the above steps, the whitelist can be an option.

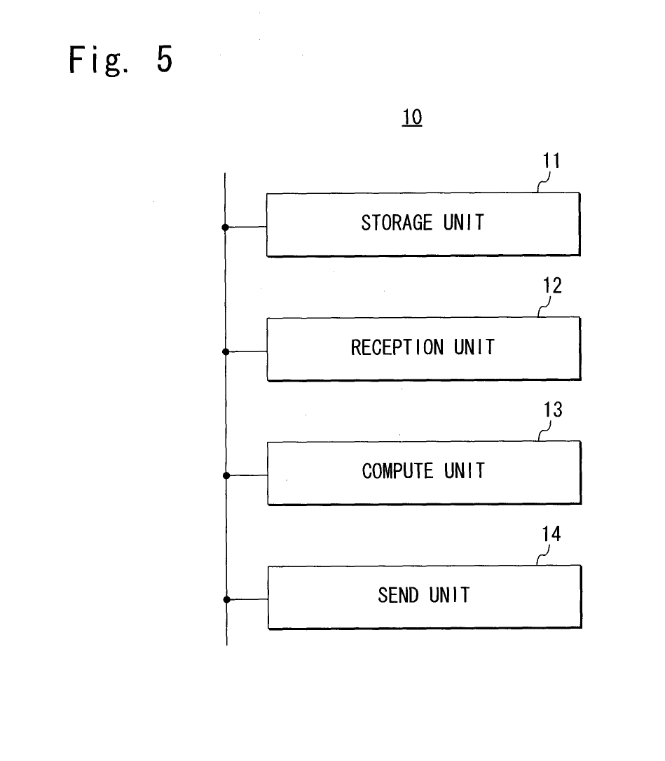

Next, configuration examples of the MTC UE 10, the group GW 20 and the MME 30 according to this exemplary embodiment will be described with reference to FIGS. 5 to 7. Note that the SGSN and the MSC can also be configured as with the MME 30. Moreover, in the following explanation, there will be described only elements which are specific to this exemplary embodiment. However, it will be understood that the MTC UE 10, the group GW 20 and the MME 30 also include elements for functioning as typical MTC UE, gateway and MME, respectively.

As shown in FIG. 5, the MTC UE 10 includes at least a storage unit 11 which stores the group key Kgr for the mutual authentication between the core network and the group member. In the case of performing the operations shown in FIG. 3, the MTC UE 10 can include a reception unit 12, a compute unit 13 and a send unit 14. The reception unit 12 receives, from the group GW 20, the AV containing the RAND and the like as shown at step S10 in FIG. 3. The compute unit 13 computes, by using the group key Kgr, the RES on the RAND as shown at step S11. The send unit 14 sends the RES to the group GW 20 as shown at step S12. On the other hand, in the case of performing the operations shown in FIG. 4, the reception unit 12 receives the AV containing the RAND from the MME 30. The compute unit 13 computes the RES1 with the group key Kgr, and computes the RES2 with the Kasme as shown at step S26 in FIG. 4. The send unit 14 sends the RES1 and RES2 to the MME 30 as shown at step S27. Note that these units 11 to 14 are mutually connected with each other through a bus or the like. These units 11 to 14 can be configured by, for example, a transceiver which conducts communication with the core network through the RAN, a controller such as a CPU (Central Processing Unit) which controls this transceiver, and a memory used by the transceiver and/or the controller.

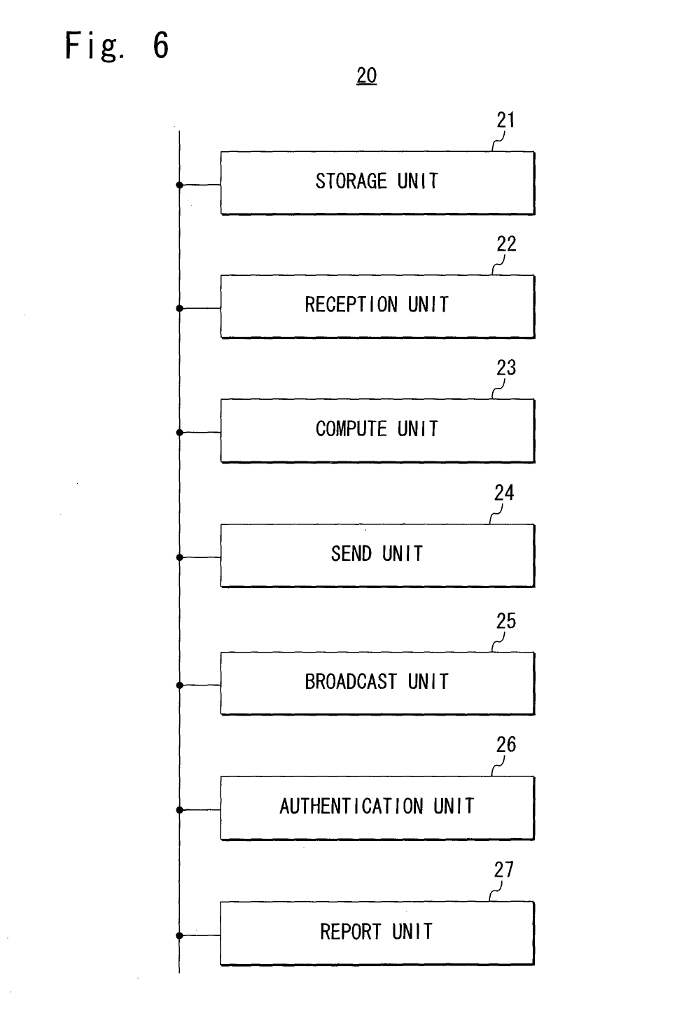

As shown in FIG. 6, the group GW 20 includes at least a storage unit 21 which can store the group keys Kgr and Kgw. The group GW 20 can include a reception unit 22, a compute unit 23, a send unit 24, a broadcast unit 25, an authentication unit 26, and a report unit 27. The reception unit 22 receives, from the MME 30, the AV containing the RAND and the like as shown at step S5 in FIG. 3. The compute unit 23 computes the RES on RAND with the group key Kgw as shown at Step S6. The send unit 24 sends the RES to the MME 30 as show at step S7. The broad cast unit 25 broadcasts, to the WC UEs 10_1 to 10_n, the AV containing the RAND and the like as shown at step S10. As shown step S13, the authentication unit 26 authenticates each of the MTC UEs 10_1 to 10_n, by checking the RES received from each of the MTC UEs 10_1 to 10_n. The report unit 27 reports IDs of authenticated MTC UEs to the MME 30 as shown at step S14. Note that these units 21 to 27 are mutually connected with each other through a bus or the like. These units 21 to 27 can be configured by, for example, a transceiver which conducts communication with the MTC UE 10, a transceiver which conducts communication with the MME 30, a controller such as a CPU which controls these transceivers, and a memory used by the transceivers and/or the controller.

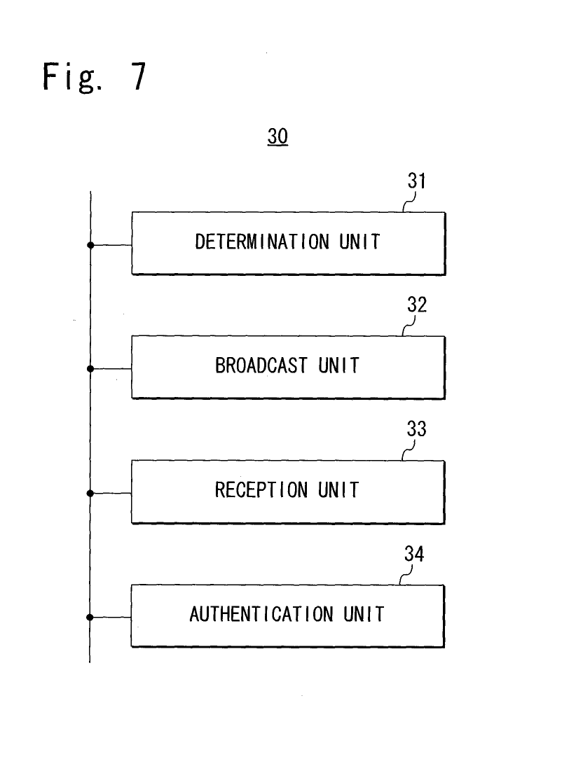

As shown in FIG. 7, the MME 30 includes at least a determination unit 31. For example, the determination unit 31 performs the operation as shown at steps S5 to S9 in FIG. 3, thereby determining whether or not to allow the group GW 20 to broad cast the Authentication

Request message to the MTC UEs 10_1 to 10_n. In this case, the MME can include a broadcast unit 32 and a reception unit 33. The broadcast unit 32 broadcasts, to the group GW 20, the AV containing the RAND and the like as shown at step S5. The reception unit 33 receives the RES on the RAND from the group GW 20 as shown at step S7. Upon the determination, the determination unit 31 verifies the RES as shown at step S8. In the case of performing the operations shown in FIG. 4, the MME 30 can further include an authentication unit 34. In this case, the broadcast unit 32 broadcasts, to the MTC UEs 10_{—} 1 to 10_n, the AV containing the RAND and the like as shown at step S25 in FIG. 4. The reception unit 33 receives the RES1 and RES2 from each of the MTC UEs 10_1 to 10 n as shown at step S27. The authentication unit 34 authenticates each of the MTC UEs 10_1 to 10_n as the group member and an individual, by verifying the RES1 and RES2 as shown at step S28. Note that these units 31 to 34 are mutually connected with each other through a bus or the like. These units 31 to 34 can be configured by, for example, a transceiver which conducts communication with the MTC UE 10 through the RAN, and a controller such as a CPU which controls this transceiver.

Based on the above description, solutions will be proposed to 3GPP TR 33.868 as follows.

For UE communicates as a group member, it should be authenticated to network 1) as an individual (as described in 33.401) and 2) as a group member. For 2), the current TR showed two options of group authentication in 5.7.4.4. While how the authentication can be performed is not provided yet.

Network may need to authenticate the group of UEs at the same time and also need to authenticate the UE individually. In this document, we discuss the solutions for group authentication in different cases.

### [1]. Authentication for All UEs in the Same Group at the Same Time

There can be a need for network to perform group authenticate at the same time, for example when SCS actives and configures the group of UEs the first time, or reconnected to network again. This requires network to have an efficient means to perform authentication instead of authenticating UE one by one. (UE at this time may or may not have already authenticated to network)

### 1) Authentication in Broadcasting Message

In AKA procedure of UE authentication, the AV is different for each UE. While for MTC group, UEs in the same group share the same group ID and group key, such that the authentication vector can be the same for all the group member of UEs.

We propose that network broadcasts the Authentication Request message containing group ID and a RES to the target group of UEs. UEs are preconfigured with a group key and a local group ID it belongs to. The details are described below.

1. MME retrieves UE subscription data, and AV for authentication.

2. MME broadcasts the Authentication Request towards target group of UEs with group ID and AV.

3. The UE which stores the same group ID will compute RES1 by using its preconfigured group key of Kgr and RES2 by using Kasme if UE has already have Kasme.

4. UE sends Authentication Response with RES1 and RES2 (optional).

5. MME can check RES1 and RES2 (optional) with the XRES1 and XRES2 it retrieved from HSS.

Note: the group key Kgr is for authentication purpose. It can be different from group key for later group messaging.

### 2) Authentication in Concatenated Message

The above solution requires MME to be responsible for group authentication, which may overload MME when UEs send Authentication Response in the same time period. An option is to use UE GW (described in TR 23.887, clause 8.1.3.3) to relay the messages for authentication.

We propose that the UE GW receives and distributes concatenated messages from/to

MME and UEs. MME sends a concatenated Authentication Request which contains the Authentication Request messages to all the group members. UE GW distributes the message to the target UEs and when UE GW received Authentication Response messages from the UEs, it can send a concatenated Authentication Response to MME.

### [2]. Authentication for UEs Separately

There can be group members that are not or cannot be activated at the same time or a UE joins to an existing group. Network can broadcast features of a group. A device which has the matched features can respond to it by sending a request of joining the group. Network then can perform authentication to the UE.

### [3]. SCS Authorization

Step 2 and 3 in TR 23.887 clause 8.1.3.2.1.1 can be used for SCS authorization, which is not necessarily for only MBMS based group messaging.

[4]. Distinguishing Group Messages from Other Messages

Group ID in the group message can be used for distinguishing the group message from other messages.

### [5]. Group Message Protection (and Key Management)

In order to provide confidentiality, integrity and replay protection for the group message, we propose a pair of group keys contain confidential and integrity keys.

The pair of group keys can be derived at HSS and sent to MME. After UE is authenticated as a group member to the network, MME can send the group keys to UE in NAS messages, for example, NAS SMC or Attach Accept message. During transmission, the group keys should be confidential and integrity protected with NAS security context. When a group GW (like UE GW described in TR23.887) is deployed, the group GW can distribute the group keys in concatenated messages.

When only end-to-end security between UE and SCS is needed, the pair of group keys can be shared between UE and SCS. Network elements like MTC-IWF only forwards the protected group messages.

Assuming the group GW is the start point to broadcast or multicast the group messages, which can be deployed on eNB, MME or MTC-IWF, the pair of group keys can be shared between UE and group GW. The group message transferring between group GW and SCS can be protected by IPsec or other existing network security solution. Group GW uses the group keys to protect the group message and broadcasts/multicasts it to the target group UEs.

In our previous patent file, group keys can be either derived at HSS or GW; can be shared between 1) UE and GW, 2) UE and SCS 3) UE-GW-SCS.

### [6]. Local Group ID

The external and local group identifiers are described in TR 23.887 clause 8.4.3.

Note that the present invention is not limited to the above-mentioned exemplary embodiment, and it is obvious that various modifications can be made by those of ordinary skill in the art based on the recitation of the claims.

The whole or part of the exemplary embodiment disclosed above can be described as, but not limited to, the following supplementary notes.

### (Supplementary Note 1)

UE is configured with a group key Kgr for group authentication.

### (Supplementary Note 2)

Group GW is configured with a group key Kgr and optionally Kgw for group authentication.

### (Supplementary Note 3)

MME broadcasts trigger for group authentication to group GW, containing local group ID, and AV (RAND, AUTN).

### (Supplementary Note 4)

Group GW computes a response RES by using a preconfigured key Kgw, which can be the same with group key Kgr.

### (Supplementary Note 5)

MME authenticates the group by verifying the RES received from group GW.

### (Supplementary Note 6)

Group GW broadcasts the Authentication Request to UEs, containing local group ID and AV.

### (Supplementary Note 7)

Group GW authenticates the UEs by comparing the RES received from UE and the value it computes with the configured Kgr on the same RAND.

### (Supplementary Note 8)

Group GW reports the authenticated UE IDs to MME.

### (Supplementary Note 9)

MME broadcasts Authentication Request to UEs with local group ID and AV.

### (Supplementary Note 10)

UE computes two responses on the received RAND, one for group authentication by using preconfigured group key Kgr, and one for individual authentication by using Kasme.

### (Supplementary Note 11)

UE sends Authentication Response with two responses (RES1 and RES2).

### (Supplementary Note 12)

MME performs authentication on UE as a group member and an individual the same time by verifying the two responses received from UE.

This application is based upon and claims the benefit of priority from Japanese patent application No. 2013-002982, filed on Jan. 10, 2013, the disclosure of which is incorporated herein in its entirety by reference.

### REFERENCE SIGNS LIST

10, 10_1-10_n MTC UE
11, 21 Storage Unit
12, 22,33 Reception Unit
13, 23 Compute Unit
14, 24 Send Unit
20 Group GW
25, 32 Broadcast Unit
26, 34 Authentication Unit
27 Report Unit
30 MME
31 DETERMINATION UNIT
40 HSS
50 MTC-IWF
60 SCS

1. (canceled)

2. A communication system comprising:
a group of MTC devices that communicate with a server through a network; and
a gateway to the network for the MTC devices,
wherein the gateway is configured with a first group key for authenticating the MTC device as a member of the group.

3. The communication system according to claim 2, further comprising:
a node that forms the network and relays traffic between the gateway and the server,
wherein the gateway is further configured with a second group key for the node to determine whether or not to allow the gateway to broadcast a message to the MTC devices.

4. The communication system according to claim 3,
wherein the node broadcasts, to the gateway, an AV (authentication vector) containing at least a RAND (random number),
the gateway computes a RES (authentication response) on the RAND by using the second group key, and
the node verifies the RES received from the gateway upon the determination.

5. The communication system according to claim 2,
wherein the gateway is further configured to:
broadcast, to the MTC devices, an AV containing at least a RAND; and
authenticate each of the MTC devices by comparing a RES on the RAND received from each of the MTC devices and a RES on the RAND computed with the first group key.

6. The communication system according to claim 2, further comprising:
a node that forms the network and relays traffic between the gateway and the server,
wherein the gateway reports, to the node, identifiers of authenticated MTC devices.

7-10. (canceled)

11. A gateway to a network for a group of MTC devices that communicate with a server through the network, the gateway comprising:
a storage unit that stores a pre-configured first group key for authenticating the MTC device as a member of the group.

12. The gateway according to claim 11, wherein the storage unit is further configured to store a pre-configured second group key for a node to determine whether or not to allow the gateway to broadcast a message to the MTC devices, the node forming the network and relaying traffic between the gateway and the server.

13. The gateway according to claim 12, further comprising:
a reception unit that receives, from the node, an AV containing at least a RAND;
a compute unit that computes, by using the second group key, a RES on the RAND; and
a send unit that sends the RES to the node in order that the node verifies the RES upon the determination.

14. The gateway according to claim 11, further comprising:
a broadcast unit that broadcasts, to the MTC devices, an AV containing at least a RAND; and
an authentication unit that authenticates each of the MTC devices by comparing a RES on the RAND received from each of the MTC devices and a RES on the RAND computed with the first group key.

15. The gateway according to claim 11, further comprising:
a report unit that reports identifiers of authenticated MTC devices to a node that forms the network and relays traffic between the gateway and the server.

16. A node that forms a network, and that relays traffic between a gateway to the network for a group of MTC devices and a server communicating with the MTC devices through the network, the node comprising:
a determination unit that determines whether or not to allow the gateway to broadcast a message to the MTC devices.

17. The node according to claim 16, further comprising:
a broadcast unit that broadcasts, to the gateway, an AV containing at least a RAND; and
a reception unit that receives a RES on the RAND from the gateway, the RES being computed by use of a pre-configured group key,
wherein the determination unit is configured to verify the RES upon the determination.

18. (canceled)

19. The node according to claim 16, comprising an MME (Mobility Management Entity), an SGSN (Serving GPRS (General Packet Radio Service) Support Node), or an MSC (Mobile Switching Centre).

20-21. (canceled)

22. A method for a network including a group of MTC devices that communicate with a server through the network and a gateway to the network for the MTC devices, the method comprising:
a step that the gateway is configured with a first group key for authenticating the MTC devices as a member of the group.

23-24. (canceled)

25. The method according to claim 22, wherein the network includes a node that forms the network and relays traffic between the gateway and the server, the method further comprising:
configuring the gateway with a second group key for the node to determine whether or not to allow the gateway to broadcast a message to the MTC devices.
